(19) United States
(12) Patent Application Publication
(10) Pub. No.: US 2024/0097201 A1
(43) Pub. Date: Mar. 21, 2024

(54) WOUND ELECTRODE BODY, SECONDARY BATTERY, AND MANUFACTURING METHOD FOR THE SECONDARY BATTERY

(71) Applicant: Prime Planet Energy & Solutions, Inc., Tokyo (JP)

(72) Inventors: Atsushi KAWAMURA, Kakogawa-shi (JP); Tomoyuki YAMADA, Kobe-shi (JP)

(21) Appl. No.: 18/465,979

(22) Filed: Sep. 13, 2023

(30) Foreign Application Priority Data
Sep. 15, 2022 (JP) 2022-146625

(51) Int. Cl. H01M 10/0587; H01M 4/13; H01M 50/46; H01M 50/463; H01M 50/609

(52) U.S. Cl. CPC H01M 10/0587; H01M 4/13; H01M 50/461; H01M 50/463; H01M 50/609; H01M 2004/021

(57) ABSTRACT

A manufacturing method for a secondary battery disclosed herein includes: a first step of manufacturing a wound electrode body with a flat shape by stacking a first separator, a positive electrode, a second separator, and a negative electrode and winding the stack; a second step of disposing the wound electrode body in a battery case; and a third step of injecting an electrolyte solution into the battery case. In the first step, the wound electrode body is manufactured in a manner that when peel strength between the first separator and the negative electrode is A (N/m) and peel strength between the second separator and the negative electrode is B (N/m), a difference between the peel strength A and the peel strength B is 0.5 (N/m) or more.

### CROSS REFERENCE TO RELATED APPLICATION

This application claims the benefit of priority to Japanese Patent Application No. 2022-146625 filed on Sep. 15, 2022. The entire contents of this application are hereby incorporated herein by reference.

### BACKGROUND OF THE DISCLOSURE

### 1. Field

The present disclosure relates to a wound electrode body, a secondary battery, and a manufacturing method for the secondary battery.

### 2. Background

A battery is conventionally known which has a wound electrode body with a flat shape resulting from stacking a positive electrode with a band shape and a negative electrode with a band shape across a separator with a band shape and winding the stack. In regard to this, for example, WO 2020/111222 describes that when a positive electrode is bonded to a separator and a negative electrode is bonded to the separator in a wound electrode body, the electrode (positive electrode or negative electrode) does not peel off the separator easily even if charging voltage is set to as high as 4.38 V or more.

### SUMMARY

Studies by the present inventors have revealed that the art described above needs to be improved further from the viewpoint of balancing the suppression of springback and a high liquid injection property (impregnation property). That is to say, in the flat-shaped wound electrode body, in a lapse of time from molding in the flat shape to insertion into the battery case, there arise forces that urge restoring of the cylindrical shape (this phenomenon will hereafter be referred to as “springback”). Ordinarily this tendency becomes more prominent as dimensions of the wound electrode body increase and the length (width) thereof becomes longer in a winding axis direction. Upon occurrence of springback, the inter-electrode distance between positive and negative electrodes widens, resistance increases, and charge carrier (for example, Li) precipitation tends to occur, for example. It is moreover difficult to accommodate, in the battery case, a wound electrode body in which springback has occurred, and to electrically connect the wound electrode body to electrode terminals, which may translate into lowered production efficiency.

Here, when a wound electrode body with a flat shape is manufactured using two separators (first separator and second separator), the art in WO 2020/111222 suggests to make peel strength (bonding strength) between the first separator and the negative electrode substantially the same as peel strength (bonding strength) between the second separator and the negative electrode. However, studies by the present inventors have revealed the problem that the liquid injection property (impregnation property) of the wound electrode body becomes worse when both the peel strength between the first separator and the negative electrode and the peel strength between the second separator and the negative electrode are increased in order to suppress the occurrence of springback. On the contrary, springback becomes large and precipitation resistance of charge carriers becomes worse when both the peel strength between the first separator and the negative electrode and the peel strength between the second separator and the negative electrode are decreased in order to increase the liquid injection property (impregnation property).

The present disclosure has been made in view of the above circumstances and it is a main object thereof to provide a secondary battery with a high liquid injection property in which the occurrence of springback is suppressed and a manufacturing method for the same.

The present disclosure provides a manufacturing method for a secondary battery, including: a first step of manufacturing a wound electrode body with a flat shape by stacking a first separator with a band shape, a positive electrode with a band shape, a second separator with a band shape, and a negative electrode with a band shape and winding the stack using a winding axis as a center; a second step of disposing one or a plurality of the wound electrode bodies in a battery case; and a third step of injecting an electrolyte solution into the battery case. In the first step, the wound electrode body is manufactured in a manner that when peel strength between the first separator and the negative electrode is A (N/m) and peel strength between the second separator and the negative electrode is B (N/m), a difference between the peel strength A and the peel strength B is 0.5 (N/m) or more.

In the manufacturing method disclosed herein, before the third step of injecting the electrolyte solution, the difference between the peel strength A between the first separator and the negative electrode and the peel strength B between the second separator and the negative electrode in the wound electrode body is set to 0.5 N/m or more. Thus, the occurrence of springback is suppressed, and the secondary battery with excellent Li precipitation resistance and liquid injection property (impregnation property) can be achieved. That is to say, since the peel strength between one of the separators and the negative electrode is increased relative to the peel strength between the other separator and the negative electrode, the shape retaining property of the wound electrode body is increased and the occurrence of springback can be suppressed in the second step, for example. Moreover, since the peel strength between the other separator and the negative electrode is decreased relative to the peel strength between the one separator and the negative electrode, the electrolyte solution easily soaks into the wound electrode body from between the separator and the negative electrode and the liquid injection property (impregnation property) can be increased.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a perspective diagram illustrating schematically a secondary battery according to an embodiment;

FIG. 2 is a schematic longitudinal cross-sectional diagram along line II-II in FIG. 1;

FIG. 3 is a schematic longitudinal cross-sectional diagram along line in FIG. 1;

FIG. 4 is a schematic transversal cross-sectional diagram along line IV-IV in FIG. 1;

FIG. 5 is a perspective diagram illustrating schematically a plurality of wound electrode bodies attached to a sealing plate;

FIG. 6 is a schematic partial cross-sectional diagram of an upper end part of the wound electrode body;

FIG. 7 is a schematic diagram illustrating a structure of the wound electrode body;

FIG. 8 is a schematic diagram illustrating interfaces between a negative electrode and two separators; and

FIG. 9 is a graph expressing a relation between surface roughness of an adhesive layer of the separator and peel strength.

### DETAILED DESCRIPTION OF THE PREFERRED EMBODIMENTS

Preferred embodiments of the art disclosed herein will be explained next with reference to accompanying drawings. Incidentally, matters other than matters particularly mentioned in the present specification, and necessary for the implementation of the art disclosed herein (for example, the general configuration and manufacturing process of a secondary battery that do not characterize the present disclosure) can be grasped as design matters of those skilled in the art based on the conventional art in the relevant field. The art disclosed herein can be implemented on the basis of the disclosure of the present specification and common technical knowledge in the relevant field. In the present specification, the notation “A to B” for a range signifies a value “equal to or more than A and equal to or less than B”, and is meant to encompass also the meaning of being “larger than A” and “smaller than B”.

In the present specification, the term “secondary battery” denotes a power storage device in general that can be repeatedly charged and discharged as a result of the movement of charge carriers across a positive electrode and a negative electrode via an electrolyte solution. The secondary batteries include not only so-called storage batteries (chemical batteries) such as lithium ion secondary batteries and nickel-hydrogen batteries, but also, for example, capacitors (physical batteries) such as electrical double layer capacitors. Embodiments of a lithium ion secondary battery will be explained next.

<Structure of Secondary Battery>

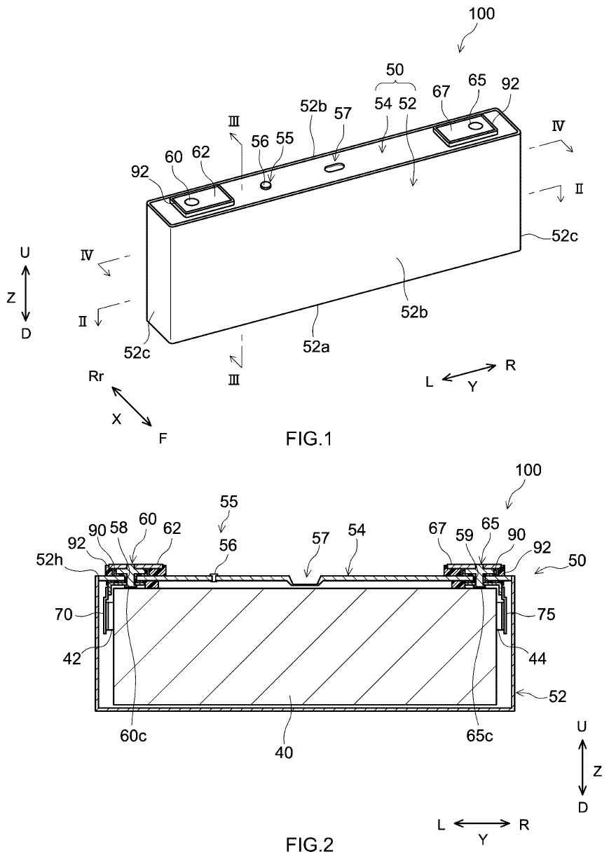

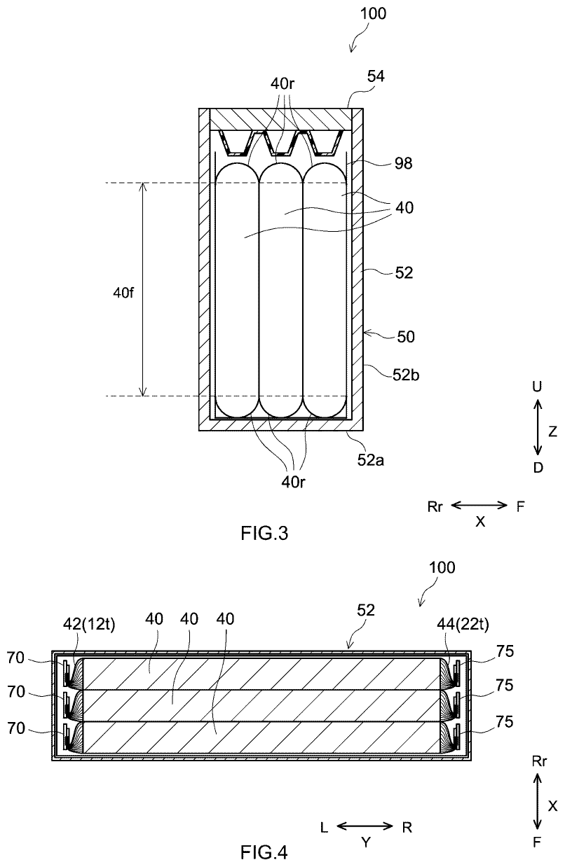

FIG. 1 is a perspective diagram of a secondary battery 100 according to the present embodiment. FIG. 2 is a schematic longitudinal cross-sectional diagram along line II-II in FIG. 1. FIG. 3 is a schematic longitudinal cross-sectional diagram along line in FIG. 1. FIG. 4 is a schematic transversal cross-sectional diagram along line IV-IV in FIG. 1. In the following description, the reference sign X denotes a “depth direction”, the reference sign Y denotes a “width direction”, and the reference sign Z denotes a “height direction”. Further, the reference symbol F in the depth direction X denotes “front” and Rr denotes “rear”. The reference symbol L in the width direction Y denotes “left” and R denotes “right”. The reference symbol U in the height direction Z denotes “up” and D denotes “down”. These directions are defined however for convenience of explanation, and are not intended to limit the manner in which the secondary battery 100 is installed.

As illustrated in FIG. 2, the secondary battery 100 includes a wound electrode body 40, an electrolyte solution (not shown), a battery case 50 that accommodates the wound electrode body 40 and the electrolyte solution, a positive electrode terminal 60, and a negative electrode terminal 65. The secondary battery 100 is a nonaqueous electrolyte secondary battery. The secondary battery 100 is preferably the nonaqueous electrolyte secondary battery such as a lithium ion secondary battery. The secondary battery 100 is characterized by including the wound electrode body 40 disclosed herein, and the other structures may be similar to those in the related art.

The battery case 50 is a housing that accommodates the wound electrode body 40 and the electrolyte solution. As illustrated in FIG. 1, the external shape of the battery case 50 here is a flat and bottomed cuboid shape (rectangular shape). A conventionally known material can be used in the battery case 50, without particular limitations. The battery case 50 may be made of metal. Examples of the material of the battery case 50 include aluminum, aluminum alloys, iron, iron alloys, and the like. As illustrated in FIG. 1 and FIG. 2, the battery case 50 includes an exterior body 52 and a sealing plate 54. The battery case 50 is preferably a rectangular battery including the exterior body 52 and the sealing plate 54.

As illustrated in FIG. 2, the exterior body 52 is a flat and bottomed rectangular container having an opening 52h in the top face. As illustrated in FIG. 1, the exterior body 52 has a bottom wall 52a with a substantially rectangular shape in a plan view, a pair of long side walls 52b extending upward in the height direction Z from the long sides of the bottom wall 52a and opposing each other, and a pair of short side walls 52c extending upward in the height direction Z from the short sides of the bottom wall 52a and opposing each other. The bottom wall 52a opposes the opening 52h. The short side wall 52c is smaller in area than the long side wall 52b.

As illustrated in FIG. 2, the sealing plate 54 is a plate-shaped member that plugs the opening 52h of the exterior body 52. The sealing plate 54 has a substantially rectangular shape in the plan view. A peripheral edge of the sealing plate 54 is joined (for example, joined by welding) to the opening 52h of the exterior body 52. Accordingly, the battery case 50 is hermetically sealed (closed). The sealing plate 54 is provided with a liquid injection hole 55, a gas discharge valve 57, and two terminal insertion holes 58, 59. The liquid injection hole 55 is a through-hole for the purpose of injecting the electrolyte solution into the battery case 50 after the sealing plate 54 is assembled to the exterior body 52. The liquid injection hole 55 is sealed with a sealing member 56 after injection of the electrolyte solution. The gas discharge valve 57 is a thin-walled portion designed to break (to open) when the pressure in the battery case 50 becomes more than or equal to a predetermined value so as to discharge the gas to the outside.

The electrolyte solution may be similar to that in the related art and is not particularly limited. The electrolyte solution is, for example, a nonaqueous electrolyte solution containing a nonaqueous solvent (organic solvent) and a supporting salt (electrolyte salt). The electrolyte solution is preferably the nonaqueous electrolyte solution. Examples of the nonaqueous solvent include carbonates such as ethylene carbonate, dimethyl carbonate, and ethyl methyl carbonate. Examples of the supporting salt include fluorine-containing lithium salts such as lithium hexafluorophosphate (LiPF₆). The electrolyte solution may contain an additive as necessary.

The positive electrode terminal 60 is attached to one end part (left end part in FIG. 1 and FIG. 2) of the sealing plate 54 in the width direction Y. The negative electrode terminal 65 is attached to the other end part (right end part in FIG. 1 and FIG. 2) of the sealing plate 54 in the width direction Y. As illustrated in FIG. 2, the positive electrode terminal 60 and the negative electrode terminal 65 extend from the inside to the outside of the sealing plate 54 through the terminal insertion holes 58 and 59. A gasket 90 made of resin is fitted to each of the terminal insertion holes 58, 59 of the sealing plate 54. As a result, the positive electrode terminal 60 and the negative electrode terminal 65 inserted into the terminal insertion holes 58, 59 are insulated from the sealing plate 54.

As illustrated in FIG. 1 and FIG. 2, the positive electrode terminal 60 is connected to a positive electrode external conductive member 62 with a plate shape, on an outer surface of the sealing plate 54. The negative electrode terminal 65 is connected to a negative electrode external conductive member 67 with a plate shape. Each of the positive electrode external conductive member 62 and the negative electrode external conductive member 67 is insulated from the sealing plate 54 by an external insulating member 92 made of resin. The positive electrode external conductive member 62 and negative electrode external conductive member 67 are connected to another battery or an external device via an external connecting member (bus bar or the like).

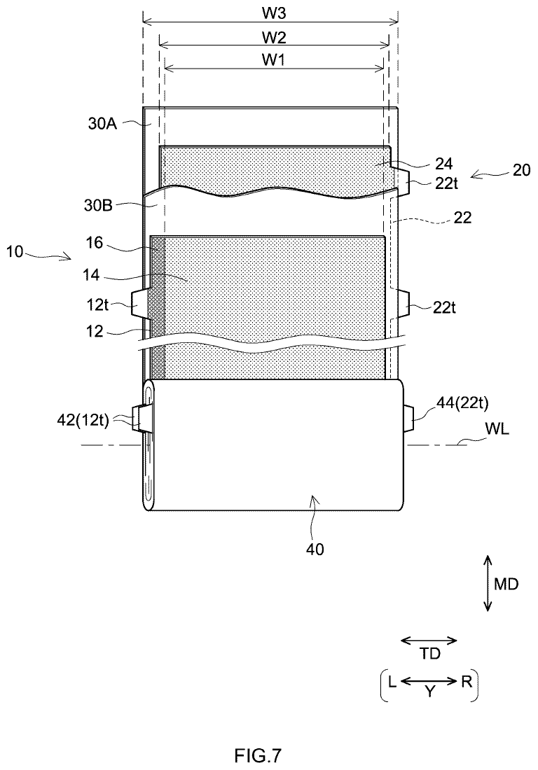

As illustrated in FIG. 2, a lower end part 60c of the positive electrode terminal 60 is connected to a positive electrode current collection member 70 inside the exterior body 52. The positive electrode terminal 60 is connected to a positive electrode 10 of the wound electrode body 40 (see FIG. 7) through the positive electrode current collection member 70. A lower end part 65c of the negative electrode terminal 65 is connected to a negative electrode current collection member 75 inside the exterior body 52. The negative electrode terminal 65 is connected to a negative electrode 20 of the wound electrode body 40 (see FIG. 7) through the negative electrode current collection member 75.

FIG. 5 is a perspective diagram illustrating schematically a plurality of the wound electrode bodies 40 attached to the sealing plate 54. In the secondary battery 100, the plurality (more specifically, three) of wound electrode bodies 40 are accommodated in the battery case 50 while being arranged in the depth direction X, as illustrated in FIG. 3 to FIG. 5. In such a structure, springback is likely to occur in particular, and the impregnation with the electrolyte solution decreases easily especially in the wound electrode body 40 in the center in the depth direction X. Thus, it is particularly effective to apply the art disclosed herein. However, the number of wound electrode bodies 40 disposed in one battery case 50 is not particularly limited, and the disposed wound electrode bodies 40 may be two or more (plural), or just one.

As illustrated in FIG. 2 and FIG. 4, a positive electrode tab group 42 is provided on one end part (left end part) of the wound electrode body 40 in the width direction Y, and a negative electrode tab group 44 is provided on the other end part (right end part). The positive electrode current collection member 70 is attached to the positive electrode tab group 42. The positive electrode tab group 42 is connected to the positive electrode terminal 60 through the positive electrode current collection member 70. The negative electrode current collection member 75 is attached to the negative electrode tab group 44. The negative electrode tab group 44 is connected to the negative electrode terminal 65 through the negative electrode current collection member 75. The secondary battery 100 has a so-called lateral tab structure in which the positive electrode tab group 42 and the negative electrode tab group 44 exist on a left side and a right side of the wound electrode body 40. However, the secondary battery 100 may have a so-called upper tab structure in which the positive electrode tab group 42 and the negative electrode tab group 44 exist on an upper side and a lower side of the wound electrode body 40.

As illustrated in FIG. 3, the wound electrode body 40 has a flat external shape. The wound electrode body 40 with a flat shape has a pair of curved portions 40r having curved outer surfaces, and a flat portion 40f having a flat outer surface and connecting the pair of curved portions 40r. As illustrated in FIG. 2 and FIG. 5, each of the plurality of wound electrode bodies 40 is disposed inside the battery case 50 in a direction in which a winding axis WL (see FIG. 7) is parallel to the width direction Y of the secondary battery 100. The pair of curved portions 40r oppose the bottom wall 52a of the exterior body 52 and the sealing plate 54. The pair of flat portions 40f oppose the pair of long side walls 52b of the exterior body 52. Here, the plurality of wound electrode bodies 40 are accommodated inside the exterior body 52 in a state of being covered with an electrode body holder 98 made of an insulating resin sheet.

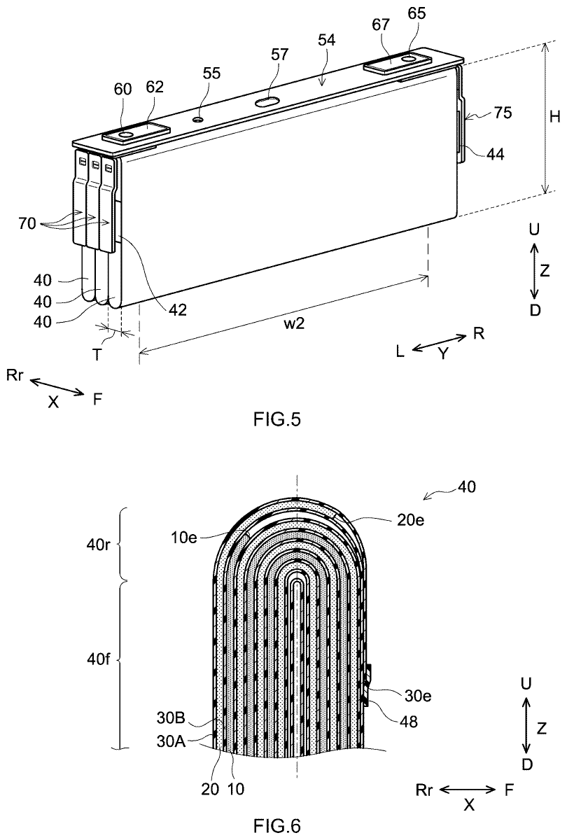

FIG. 6 is a schematic partial cross-sectional diagram illustrating a cross section perpendicular to the winding axis direction of the wound electrode body 40. FIG. 7 is a schematic diagram illustrating the structure of the wound electrode body 40. The reference sign MD in FIG. 7 and so forth signifies a longitudinal direction (i.e., transport direction) of the wound electrode body 40 and separators 30A and 30B, and denotes herein a machine direction. The reference sign TD signifies a direction perpendicular to the “MD direction”, and denotes herein a “width direction (transverse direction)”. The “TD direction” here is the same direction as the width direction Y of the aforementioned secondary battery 100.

As illustrated in FIG. 7, the wound electrode body 40 is configured by stacking the positive electrode 10 with a band shape and the negative electrode 20 with a band shape on each other, while insulated from each other by the two separators 30A and 30B with a band shape, and by winding the stack in the longitudinal direction using the winding axis WL as a center. Such a wound electrode body 40 with a flat shape can be formed, for example, by press molding of an electrode body wound to a tubular shape (tubular body) to be described in a manufacturing method below. Alternatively, as described in WO 2020/111222, for example, the wound electrode body 40 with a flat shape can be formed by winding the positive electrode 10 with a band shape, the negative electrode 20 with a band shape, and the two separators 30A and 30B with a band shape to a flat shape.

As illustrated in FIG. 6, a winding terminal end 10e of the positive electrode 10 is disposed on an inner peripheral side of the winding relative to a winding terminal end 20e of the negative electrode 20. The winding terminal end 20e of the negative electrode 20 is disposed on an outer peripheral side of the winding relative to the winding terminal end 10e of the positive electrode 10. Winding terminal ends 30e of the separators 30A and 30B are disposed on the outer peripheral side of the winding relative to the winding terminal end 10e of the positive electrode 10 and the winding terminal end 20e of the negative electrode 20. The outermost periphery of the wound electrode body 40 is formed by the separator 30A. The winding terminal ends 30e of the separators 30A and 30B here are positioned in the flat portion 40f of the wound electrode body 40. A winding stop tape 48 is attached to each winding terminal end 30e of the separators 30A and 30B.

A thickness T (see FIG. 5) of the wound electrode body 40 is preferably 5 mm or more and more preferably 8 mm or more, and is preferably 30 mm or less and more preferably 20 mm or less. An elastic action elicited by the curved portions 40r after the press molding increases with the increasing thickness T. As a result, springback in which the flat portion 40f expands on account of the residual elastic action of the curved portions 40r occurs more easily. Thus, it is particularly effective to apply the art disclosed herein. The term “thickness T of the wound electrode body 40” denotes the length (average length) of the flat portion 40f in a direction perpendicular to the flat portion 40f.

A height H (see FIG. 5) of the wound electrode body 40 is preferably 120 mm or less, and is more preferably from 60 to 120 mm, still more preferably from 80 to 110 mm, and particularly preferably from 90 to 100 mm. The term “height H of the wound electrode body 40” denotes the length (average length) in a direction perpendicular to the winding axis WL of the wound electrode body 40 and perpendicular to the thickness direction of the wound electrode body 40. Specifically, the height H denotes the length (average length) from an upper end of one of the curved portions 40r to a lower end of the other curved portion 40r.

Preferably, the number of winding turns of the wound electrode body 40 is adjusted as appropriate taking into consideration, for example, the intended performance of the secondary battery 100 and manufacturing efficiency. The number of winding turns is preferably 20 or more, and more preferably 25 or more. More winding turns result in the larger elastic action after the press molding similarly to the case where the thickness T is large. Thus, it is particularly effective to apply the art disclosed herein. A concrete structure of the wound electrode body 40 will be explained below.

The positive electrode 10 may be similar to that in the related art and is not particularly limited. The positive electrode 10 is a band-shaped member, as illustrated in FIG. 7. The positive electrode 10 includes a positive electrode core body 12 with a band shape, and a positive electrode active material layer 14 and a protective layer 16 that are fixed to at least one surface of the positive electrode core body 12. The positive electrode 10 preferably includes the positive electrode core body 12 and the positive electrode active material layer 14. The positive electrode active material layer 14 is preferably formed on both surfaces of the positive electrode core body 12, from the viewpoint of higher capacity. The protective layer 16 is not essential, and can be omitted in another embodiment. A metal foil having predetermined conductivity can be preferably used in the positive electrode core body 12. Preferably, the positive electrode core body 12 is, for example, made of aluminum or an aluminum alloy. The thickness of the positive electrode core body 12 is preferably from 5 to 30 μm, and more preferably from 10 to 20 μm.

In the positive electrode 10, positive electrode tabs 12t protrude outward (toward the left in FIG. 7) from one edge in the width direction TD. The plurality of positive electrode tabs 12t are provided at predetermined intervals in the longitudinal direction MD. The positive electrode tabs 12t are portions (current collector exposing portion) at which the positive electrode active material layer 14 is not formed and the positive electrode core body 12 is exposed. As illustrated in FIG. 4 and FIG. 7, the plurality of positive electrode tabs 12t are stacked at one end part of the secondary battery 100 in the long side direction Y (left end part in FIG. 4 and FIG. 7) and form the positive electrode tab group 42.

As illustrated in FIG. 7, the positive electrode active material layer 14 is provided to have a band shape in the longitudinal direction of the positive electrode core body 12. The positive electrode active material layer 14 includes a positive electrode active material that is capable of reversibly storing and releasing charge carriers. The positive electrode active material layer 14 preferably contains the positive electrode active material, a binder, and a conductive material. The positive electrode active material preferably contains a lithium-transition metal complex oxide. As a result, the positive electrode 10 with high performance can be achieved stably, and the occurrence of springback can be suitably suppressed. A preferred example of the lithium-transition metal complex oxide is a lithium-transition metal complex oxide represented by general formula LiMO₂ (in which M is one, or two or more types of transition metal element other than Li). Specifically, the above M element is preferably a lithium-transition metal complex oxide containing at least one from among Ni, Co and Mn, and particularly preferably is a lithium-transition metal complex oxide containing Ni. Preferably, the positive electrode active material is in the form of particles having an average particle size (D₅₀ particle size) from 2 to 20 μm.

Examples of the positive electrode binder include vinyl halide resins such as polyvinylidene fluoride (PVdF). The positive electrode binder may be made of PVdF. Examples of the conductive material include carbon black such as acetylene black (AB) and carbon materials such as graphite. The positive electrode active material layer 14 may further contain an optional component other than the above components.

The packing density of the positive electrode active material (for example, lithium-transition metal complex oxide) in the positive electrode active material layer 14 is preferably 3.0 g/cm³ or more, and more preferably 3.5 g/cm³ or more, from the viewpoint of increasing battery capacity. The positive electrode active material layer 14 with high density exhibits a large elastic action after the press molding, and thus, springback is likely to occur. Thus, it is particularly effective to apply the art disclosed herein. The packing density of the positive electrode active material layer 14 may be 6.0 g/cm³ or less and 5.0 g/cm³ or less, for example.

The thickness of the positive electrode active material layer 14 is preferably 50 to 500 pin and more preferably 100 to 300 μm. A greater thickness of the positive electrode active material layer 14 entails a greater elastic action after the press molding. Thus, it is particularly effective to apply the art disclosed herein. A width W1 of the positive electrode active material layer 14 (see FIG. 7) may be about 100 to 400 mm, for example, 200 to 350 mm. Note that the term “thickness of the active material layer” denotes, when the active material layer is formed on both surfaces of the core body, the total of the thickness on both surfaces. In addition, the term “width of the active material layer” denotes the length (average length) of the active material layer in the width direction TD of the wound electrode body 40.

The protective layer 16 is a layer configured to have lower electrical conductivity than that of the positive electrode active material layer 14. The protective layer 16 is provided in a region adjacent to an edge of the positive electrode 10 on the positive electrode tab 12t side. The protective layer 16 is formed in a band shape along the longitudinal direction MD of the positive electrode 10. By providing the protective layer 16, it becomes possible to prevent internal short circuits caused by direct contact between the positive electrode core body 12 and a negative electrode active material layer 24 when the separators 30A and 30B are damaged. Preferably, the protective layer 16 contains insulating ceramic particles such as alumina. The protective layer 16 may contain a binder for fixing the ceramic particles on the surface of the positive electrode core body 12.

The negative electrode 20 is a band-shaped member, as illustrated in FIG. 7. The negative electrode 20 includes a negative electrode core body 22 with a band shape and the negative electrode active material layer 24 that is fixed to at least one surface of the negative electrode core body 22. The negative electrode 20 preferably includes the negative electrode core body 22 and the negative electrode active material layer 24. The negative electrode active material layer 24 is preferably formed on both surfaces of the negative electrode core body 22, from the viewpoint of higher capacity. Conventionally known materials that can be used in secondary batteries in general (for example, in lithium ion secondary batteries) can be utilized, without particular limitations, in the members that form the negative electrode 20. For example, a metal foil having predetermined conductivity can be preferably used in the negative electrode core body 22. Preferably, the negative electrode core body 22 is, for example, made of copper or a copper alloy. The thickness of the negative electrode core body 22 is preferably from 5 to 30 μm, and more preferably from 5 to 15 μm.

In the negative electrode 20, negative electrode tabs 22t protrude outward (toward the right in FIG. 7) from one edge in the width direction TD. The plurality of negative electrode tabs 22t are provided at predetermined intervals in the longitudinal direction MD. The negative electrode tabs 22t are portions (current collector exposing portion) at which the negative electrode active material layer 24 is not formed and the negative electrode core body 22 is exposed. As illustrated in FIG. 4 and FIG. 7, the plurality of negative electrode tabs 22t are stacked at one end part of the secondary battery 100 in the long side direction Y (right end part in FIG. 4 and FIG. 7) and form the negative electrode tab group 44.

As illustrated in FIG. 7, the negative electrode active material layer 24 is provided to have a band shape in the longitudinal direction of the positive electrode core body 12. The negative electrode active material layer 24 includes a negative electrode active material that is capable of reversibly storing and releasing charge carriers. The negative electrode active material layer 24 preferably contains the negative electrode active material and a binder. The negative electrode active material preferably contains a carbon material such as graphite. The negative electrode active material may contain a silicon-based material. Preferably, the negative electrode active material is in the form of particles having an average particle size (D₅₀ particle size) from 3 to 25 μm.

Examples of the negative electrode binder include rubbers such as styrene-butadiene rubber (SBR) and celluloses such as carboxymethyl cellulose (CMC). The negative electrode binder may be made of SBR and CMC. The negative electrode active material layer 24 may further contain an optional component other than the above components.

The packing density of the negative electrode active material (for example, graphite) in the negative electrode active material layer 24 is preferably 1.0 g/cm³ or more and more preferably 1.4 g/cm³ or more. The packing density of the negative electrode active material layer 24 may be 3.0 g/cm³ or less and 2.0 g/cm³ or less, for example.

The thickness of the negative electrode active material layer 24 is preferably 50 to 500 μm and more preferably 100 to 300 μm. A greater thickness of the negative electrode active material layer 24 entails a greater elastic action after the press molding. Thus, it is particularly effective to apply the art disclosed herein. The negative electrode active material layer 24 covers the positive electrode active material layer 14 at both ends in the width direction TD. A width W2 of the negative electrode active material layer 24 (see FIG. 7) is preferably 200 mm or more and more preferably 250 mm or more in the relation with the width W1 of the positive electrode active material layer 14. A greater width W2 of the negative electrode active material layer 24 entails a greater size of the wound electrode body 40, and as a result entails a greater elastic action after the press molding. Thus, it is particularly effective to apply the art disclosed herein similarly to the aforementioned case where the thickness is large. The width W2 of the negative electrode active material layer 24 may be about 450 mm or less, and for example 350 mm or less.

Each of the two separators 30A and 30B is a band-shaped member, as illustrated in FIG. 7. The separators 30A and 30B are disposed between the positive electrode 10 and the negative electrode 20. The separators 30A and 30B are insulating sheets having formed therein a plurality of fine through-holes through which charge carriers can pass. Through interposition of the separators 30A and 30B between the positive electrode 10 and the negative electrode 20, it becomes possible to prevent contact between the positive electrode 10 and the negative electrode 20, and to move charge carriers (for example, lithium ions) between the positive electrode 10 and the negative electrode 20. One of the separators 30A and 30B is one example of a first separator and the other is one example of a second separator.

FIG. 8 is a schematic diagram illustrating interfaces between the negative electrode 20 and the two separators 30A and 30B. As illustrated in FIG. 8, the separator 30A includes a base material layer 32 and an adhesive layer 34A formed on at least one surface of the base material layer 32. The separator 30B includes the base material layer 32 and an adhesive layer 34B formed on at least one surface of the base material layer 32. The adhesive layers 34A and 34B may be directly provided on the surface of the base material layer 32, or may be provided on the base material layer 32 via another layer. For example, a heat-resistant layer containing an inorganic filler and a binder may be provided between the base material layer 32 and the adhesive layers 34A and 34B.

The adhesive layers 34A and 34B are provided on at least surfaces opposing the negative electrode 20. The adhesive layer 34A of the separator 30A abuts one surface (first surface) of the negative electrode 20. The adhesive layer 34B of the separator 30B abuts the other surface (second surface) of the negative electrode 20. The separators 30A and 30B preferably include the adhesive layers 34A and 34B on the surfaces opposing the negative electrode 20. The adhesive layer may also be provided on the surface opposing the positive electrode 10.

Base material layers used in separators of the conventionally known secondary batteries can be used, without particular limitations, as the base material layer 32. The base material layer 32 is preferably a porous sheet-shaped member. The base material layer 32 is preferably made of a polyolefin resin such as polyethylene (PE) or polypropylene (PP), and is more preferably made of PE. The base material layer 32 may have a single-layer structure, or may have a structure of two or more layers, for example, a three-layer structure.

The adhesive layers 34A and 34B abut the negative electrode 20 (typically the negative electrode active material layer 24). The adhesive layers 34A and 34B are integrated with the negative electrode 20 (typically the negative electrode active material layer 24) by the press molding, for example. The separators 30A and 30B are preferably bonded to the negative electrode 20 through the adhesive layers 34A and 34B, respectively. As a result, the occurrence of springback caused by the negative electrode 20 can be suppressed suitably.

Studies by the present inventors have revealed that, in a structure in which the lithium-transition metal complex oxide is used for the positive electrode active material and the carbon material (typically, graphite) is used for the negative electrode active material, the influence of the negative electrode 20 on springback of the wound electrode body 40 tends to be significant. Specifically, the lithium-transition metal complex oxide is harder than the carbon material, and exhibits a smaller displacement against compressive forces. As a result, changes such as an increase in thickness after the press molding are unlikely to occur, and the influence on springback is small. By contrast, the carbon material is relatively bulkier than the lithium-transition metal complex oxide, and exhibits a larger displacement against the compressive forces. As a result, thickness increases easily after the press molding, and the influence on springback tends to increase. Therefore, in order to suppress the occurrence of springback, it is particularly effective that the adhesive layers 34A and 34B are provided on the surfaces opposing the negative electrode 20.

The adhesive layers 34A and 34B contain an adhesive layer binder. Examples of the adhesive layer binder include resins such as fluororesins, acrylic resins, and urethane resins. Examples of fluororesins include polyvinylidene fluoride (PVdF) and polytetrafluoroethylene (PTFE). Fluororesins and acrylic resins are preferred among the foregoing, since these have high flexibility and allow bringing out more suitably adhesiveness toward the negative electrode 20. The adhesive layer binders contained in the adhesive layers 34A and 34B may be identical to or different from each other. The adhesive layers 34A and 34B may further contain other materials (for example, inorganic particles such as ceramic particles). When the adhesive layers 34A and 34B contain the inorganic particles, the content ratio of the inorganic particles is preferably suppressed to be less than or equal to 80 mass % of the total of the adhesive layers 34A and 34B.

The separators 30A and 30B cover the negative electrode active material layer 24 at both ends in the width direction TD. A width W3 of the separators 30A and 30B (see FIG. 7) is larger than the width W2 of the negative electrode active material layer 24. The width W1 of the positive electrode active material layer 14, the width W2 of the negative electrode active material layer 24, and the width W3 of the separators 30A and 30B satisfy a relationship W1<W2<W3.

In the present embodiment, when peel strength between the negative electrode 20 and one of the separators 30A and 30B is A (N/m) and peel strength between the negative electrode 20 and the other separator is B (N/m), the difference between the peel strength A and the peel strength B is preferably 0.5 (N/m) or more. However, the peel strength can be changed depending on the contact with the electrolyte solution or the charging and discharging, for example. Thus, after a charging and discharging cycle is repeated, for example, the peel strength A and the peel strength B do not need to satisfy the above relation. Note that a measurement method of “peel strength” will be described in Examples below.

<Manufacturing Method for Secondary Battery>

The aforementioned secondary battery 100 can be manufactured in accordance with a manufacturing method that includes, for example, the following steps: (1) a first step of manufacturing the wound electrode body 40 with a flat shape; (2) a second step of manufacturing a battery assembly; and (3) a third step of injecting the electrolyte solution into the battery case 50. Otherwise, the manufacturing process may be similar to conventional processes. In addition, the manufacturing method disclosed herein may further include other steps, at any stage.

The first step (1) is a step of manufacturing the wound electrode body with a flat shape using the positive electrode 10, the negative electrode 20, and the separators 30A and 30B. The first step (1) preferably includes: (1-1) a separator preparation step, (1-2) a winding process, and (1-3) a press molding step, in this order. The winding step (1-2) or the press molding step (1-3) may be followed by a drying step additionally.

In the separator preparation step (1-1), for example, the separators 30A and 30B including the adhesive layers 34A and 34B on the surfaces opposing the negative electrode 20 are prepared. Although not particularly limited, the basis weight of the adhesive layers 34A and 34B is preferably 0.5 to 10 g/m², more preferably 1 to 5 g/m², and for example, 3.5 to 4.5 g/m². Note that the term “basis weight of the adhesive layer” denotes the weight (g) of the adhesive layer with respect to the area (m²) in which the adhesive layer is formed. The separators 30A and 30B may also include the adhesive layers on the surfaces opposing the positive electrode 10.

Although not particularly limited, the surface roughness of the adhesive layers 34A and 34B is preferably 0.3 μm or more, and more preferably 0.4 μm or more. When the surfaces of the adhesive layers 34A and 34B have fine irregularities, the negative electrode 20 (typically, negative electrode active material layer 24) bites into the adhesive layers 34A and 34B on account of an anchor effect, and the separators 30A and 30B and the negative electrode 20 are easily bonded to each other. The surface roughness of the adhesive layers 34A and 34B may be about 1 μm or less, and for example 0.5 μm or less. Note that “surface roughness” denotes arithmetic mean roughness Sa that is measured based on the international standard ISO 25178.

The adhesive layer 34A of the separator 30A and the adhesive layer 34B of the separator 30B are preferably different from each other in surface roughness. Thus, in the press molding step (1-3), one surface (first surface) of the negative electrode 20 and the other surface (second surface) can be suitably made different from each other in the peel strength with respect to the separators 30A and 30B.

When each of the separators 30A and 30B also includes the adhesive layer on the surface opposing the positive electrode 10, the basis weight of the adhesive layer on the side opposing the positive electrode 10 may be relatively larger than the basis weight of the adhesive layer 34A on the side opposing the negative electrode 20. Thus, in the press molding step (1-3), the negative electrode 20 side and the positive electrode 10 side of the separators 30A and 30B can be suitably made different from each other in the peel strength.

In the winding step (1-2), there is manufactured a tubular wound body (tubular body) that is provided with the positive electrode 10 with a band shape, the negative electrode 20 with a band shape, and the separators 30A and 30B with a band shape. Specifically, a winding device provided with a winding unit is prepared first. Next, the positive electrode 10, the negative electrode 20, and the separators 30A and 30B are each wound into a respective reel that is set in the winding device. Next, the tip end parts of the two separators 30A and 30B are fixed to a winding core of the winding unit. That is, the two separators 30A and 30B are nipped by the winding core. The positive electrode 10 with a band shape and the negative electrode 20 with a band shape are next stacked on each other across two separators 30A and 30B. At this time, the adhesive layers 34A and 34B of the separators 30A and 30B are set to oppose the negative electrode 20. The winding core is caused to rotate while the positive electrode 10 with a band shape and the negative electrode 20 with a band shape are supplied, to thereby wind the positive electrode 10, the negative electrode 20, and the separators 30A and 30B. Once winding is over, the winding stop tape 48 is attached to a terminal end part of each of the separators 30A and 30B. The tubular body is manufactured thus as described above.

In the press molding step (1-3), the wound tubular body is press-molded to a flat shape, as illustrated in FIG. 7. Preferably, the press molding conditions (for example, pressure, holding time, and so forth) are regulated as appropriate in accordance with the flexibility of the adhesive layers 34A and 34B and the number of winding turns, for example. The press molding may be performed at room temperature, or may be performed while under heating (at a high temperature). As a result of the press molding, the positive electrode tab group 42 in which the positive electrode tabs 12t are stacked is formed at one end part of the wound electrode body 40 in the width direction Y, while the negative electrode tab group 44 in which the negative electrode tabs 22t are stacked is formed at the other end part. A reaction portion in which the positive electrode active material layer 14 and the negative electrode active material layer 24 oppose each other is formed in the length of the width W1 in the central portion of the wound electrode body 40 in the width direction Y.

In the present embodiment, the separator 30A and one surface (first surface) of the negative electrode 20 are bonded to each other through the adhesive layer 34A by the press molding. Moreover, the separator 30B and the other surface (second surface) of the negative electrode 20 are bonded to each other through the adhesive layer 34B. Specifically, when the tubular body is squashed at the time of the press molding, a large pressure is applied to the positive electrode 10, the negative electrode 20, and the separators 30A and 30B positioned at the flat portion 40f. At this time, the adhesive layers 34A and 34B are deformed, by being pressed, while conforming to the irregularity on the surface of the negative electrode active material layer 24. The separators 30A and 30B and the negative electrode 20 are bonded (pressure-bonded) to each other as a result.

In the present embodiment, when the peel strength between the negative electrode 20 and one of the separators 30A and 30B is A (N/m) and the peel strength between the negative electrode 20 and the other separator is B (N/m), the difference between the peel strength A and the peel strength B is 0.5 (N/m) or more. Thus, the occurrence of springback is suppressed after the press molding, and the secondary battery 100 with excellent Li precipitation resistance and liquid injection property (impregnation property) can be achieved. The difference between the peel strength A and the peel strength B is preferably 0.5 N/m or more, more preferably 0.7 N/m or more, and still more preferably 0.9 N/m or more. The effect of the art disclosed herein can be realized as a result at a high level. The difference between the peel strength A and the peel strength B may be about 2.0 N/m or less, and for example 1.6 N/m or less.

The smaller one of the peel strength A and the peel strength B is preferably 0.1 N/m or more. The smaller peel strength is preferably 0.2 to 0.7 N/m, more preferably 0.2 to 0.5 N/m, and still more preferably 0.2 to 0.3 N/m. Thus, the flat shape can be kept easily between the press molding and the second step, and the occurrence of springback can be suppressed at a higher level. On the other hand, the larger one of the peel strength A and the peel strength B is preferably 0.7 to 1.8 N/m, more preferably 1.0 to 1.8 N/m, and still more preferably 1.5 to 1.8 N/m. Thus, the inter-electrode distance is increased and the liquid injection property (impregnation property) can be increased more. Note that the value of the peel strength can be adjusted by the basis weight of the adhesive layers 34A and 34B and the surface roughness of the separators 30A and 30B, for example.

When the separator 30A also includes the adhesive layer on the surface opposing the positive electrode 10, the peel strength between the separator 30A and the positive electrode 10 may be relatively larger than the peel strength between the separator 30A and the negative electrode 20. The peel strength between the separator 30B and the positive electrode 10 may be relatively larger than the peel strength between the separator 30B and the negative electrode 20. Each peel strength between the separators 30A and 30B and the positive electrode 10 is preferably 0.8 N/m or more, more preferably 1.0 N/m or more, and still more preferably 1.2 N/m or more. Each peel strength between the separators 30A and 30B and the positive electrode 10 is preferably 2.0 N/m or less, and more preferably 1.8 N/m or less. The effect of the art disclosed herein can be realized as a result at the high level. The wound electrode body 40 including the positive electrode 10, the negative electrode 20, and the separators 30A and 30B is manufactured as described above.

In the second step (2), the wound electrode body 40 with a flat shape manufactured in the first step is disposed inside the battery case 50 and the battery assembly is manufactured. Here, the battery assembly denotes an assembly including the wound electrode body 40 and the battery case 50 that accommodates the wound electrode body 40 before the electrolyte solution is injected in the manufacturing process for the secondary battery 100. From the viewpoint of the higher capacity, the plurality of wound electrode bodies 40 are preferably disposed inside the battery case 50.

In the third step (3), the electrolyte solution is injected into the battery case 50 of the battery assembly manufactured in the second step. The electrolyte solution is preferably injected through the liquid injection hole 55 provided in the battery case 50. The secondary battery 100 can be manufactured as described above.

<Application of Secondary Battery>

The secondary battery 100 can be used for various applications, and can be suitably used, for example, as a power source (drive power source) for motors mounted on vehicles such as passenger cars and trucks. The vehicle is not limited to a particular type, and may be, for example, a plug-in hybrid electric vehicle (PHEV), a hybrid electric vehicle (HEV), or a battery electric vehicle (BEV).

Several Examples relating to the present disclosure will be explained below, but the disclosure is not meant to be limited to these Examples.

<Manufacture of Wound Electrode Body>

First, as a positive electrode, a positive electrode core body (aluminum foil with a thickness of 13 μm) in which a positive electrode active material layer (thickness: 60 μm, width: 280 mm) was added to both surfaces of the positive electrode core body was prepared. The positive electrode active material layer includes a lithium-nickel-cobalt-manganese-based complex oxide (NCM) as a positive electrode active material, acetylene black (AB) as a conductive material, and polyvinylidene fluoride (PVdF) as a binder in a mass ratio of NCM:AB:PVdF=97.5:1.5:1.0.

As a negative electrode, a negative electrode core body (copper foil with a thickness of 8 μm) in which a negative electrode active material layer (thickness: 80 μm, width: 285 mm) was added to both surfaces of the negative electrode core body was prepared. The negative electrode active material layer includes graphite (C) as a negative electrode active material, and carboxymethyl cellulose (CMC) and styrene-butadiene rubber (SBR) as a binder in a mass ratio of C:CMC:SBR=98.3:0.7:1.0.

As a separator, there were prepared two separators each having an adhesive layer (basis weight 4.0 g/m², surface roughness expressed in Table 1) formed on a surface of a base material layer made of polyethylene (PE). The adhesive layer includes alumina powder and polyvinylidene fluoride (PVdF). The content of PVdF in the adhesive layer was 25 mass %. Note that the surface roughness of the adhesive layer was calculated by observing the surface with a laser microscope and performing image processing on the obtained image.

A tubular wound body (tubular body) was manufactured by stacking the positive electrode and the negative electrode across the two separators and winding the stack through the winding step as described above. Note that the separators were disposed so that the adhesive layers opposed the negative electrode. The number of winding turns was set to 33.

<Measurement of Quantity of Springback>

The quantity of springback was measured next while the press molding step was carried out according to the procedures below.
(Procedure 1) Each tubular body manufactured above was squashed, for three seconds, to a flat shape through the press molding at a pressure of 125 kN (that is, 0.54 kN/cm², per unit area). Then, the thickness of the wound electrode body in the press molding (thickness of bottom dead center) was measured.
(Procedure 2) The thickness of the wound electrode body when 100 N was applied (100 N thickness) was measured in a predetermined time from five seconds after the press molding to one minute.
(Procedure 3) The quantity of springback (mm) was calculated on the basis of the difference between the thickness of the bottom dead center and the 100 N thickness (100 N thickness −thickness of bottom dead center). The results are given in Table 1.

<Measurement of Liquid Injection Property (Introduced Quantity of Electrolyte Solution)>

Next, an electrolyte solution was injected into the wound electrode body with a flat shape manufactured as described above, and the weight of the electrolyte solution that was introduced into the wound electrode body one time without overflow was measured. The results are given in Table 1.

<Measurement of Peel Strength>

Separately, a sample of a laminate that imitates the negative electrode and the separator positioned on the flat portion of the wound electrode body was made, and the peel strength between the negative electrode and the separator was measured. Specifically, first, the negative electrode was punched into a size of 20 mm×70 mm with a Thomson blade. Moreover, the separator including the adhesive layer and the base material layer was punched into a size of 30 mm×80 mm with the Thomson blade. Then, the negative electrode and the separator were overlapped with each other in a manner that an outer edge of the negative electrode was positioned within an outer edge of the separator, and the laminate was obtained. At this time, the adhesive layer of the separator was disposed so as to oppose the negative electrode.

Next, this laminate was set to a pressing machine and the laminate was pressed for three seconds at 7.6 kN (the same pressure as that when the wound electrode body was manufactured in terms of an area), so that the negative electrode and the separator were bonded though the adhesive layer. Next, the laminate was set to a peel testing machine and an end part of the separator was held by a clamp. Then, the separator was peeled by 20 mm in a direction of 90° and the peel strength (90° peel strength) between the negative electrode and the separator was measured while the load data was measured. The results are given in Table 1.

TABLE 1

| | Structure of separator | | | | | | | | | | | | |
|---|---|---|---|---|---|---|---|---|---|---|---|---|---|
| | Surface of first separator | | | Surface of second separator | | | | | | | | | |
| | opposing negative electrode | | | opposing negative electrode | | | | | Evaluation results | | | | |
| | Peel | Basis | Surface | Peel | Basis | Surface | Difference | | Quantity of springback | | | | Liquid injection |
| | strength A | weight | roughness | strength | weight | roughness | between | | Thickness | | (100N | | property |
| | with | of | of | B with | of | of | peel | | of bottom | | thickness − | | Introduced |
| | negative | adhesive | adhesive | negative | adhesive | adhesive | strength A | | dead | 100N | thickness | | quantity |
| | electrode | layer | layer | electrode | layer | layer | and peel | | center | thickness | of dead | | of electrolyte |
| | [N/m] | [g/m²] | [μm] | [N/m] | [g/m²] | [μm] | strength B | | [mm] | [mm] | center) | | solution |
| Example 1 | 0.9 | 4.0 | 0.43 | 1.8 | 4.0 | 0.41 | 0.9 | N/m | 11.48 | 11.94 | 0.48 | mm | 246.4 g |
| Example 2 | 1.8 | 4.0 | 0.41 | 0.2 | 4.0 | 0.48 | 1.6 | N/m | 11.42 | 12.23 | 0.81 | mm | 246.4 g or more |
| | | | | | | | | | | | | | (between |
| | | | | | | | | | | | | | Example 1 and |
| | | | | | | | | | | | | | Comparative |
| | | | | | | | | | | | | | Example 2) |
| Example 3 | 0.7 | 4.0 | 0.45 | 0.2 | 4.0 | 0.48 | 0.5 | N/m | 11.43 | 12.28 | 0.85 | mm | 246.4 g or more |
| | | | | | | | | | | | | | (between |
| | | | | | | | | | | | | | Example 1 and |
| | | | | | | | | | | | | | Comparative |
| | | | | | | | | | | | | | Example 2) |
| Comparative | 0.3 | 4.0 | 0.47 | 0.3 | 4.0 | 0.47 | 0 | N/m | 11.43 | 12.63 | 1.20 | mm | (Substantially |
| Example 1 | | | | | | | | | | | | | the same as |
| | | | | | | | | | | | | | that in |
| | | | | | | | | | | | | | Comparative |
| | | | | | | | | | | | | | Example 2) |
| Comparative | 0.2 | 4.0 | 0.48 | 0.2 | 4.0 | 0.48 | 0 | N/m | 11.42 | 12.55 | 1.13 | mm | 248.42 g |
| Example 2 | | | | | | | | | | | | | |
| Comparative | 0.2 | 4.0 | 0.48 | 0.3 | 4.0 | 0.47 | 0.1 | N/m | 11.42 | 12.61 | 1.19 | mm | (Substantially |
| Example 3 | | | | | | | | | | | | | the same as |
| | | | | | | | | | | | | | that in |
| | | | | | | | | | | | | | Comparative |
| | | | | | | | | | | | | | Example 2) |
| Comparative | 1.8 | 4.0 | 0.41 | 1.8 | 4.0 | 0.41 | 0 | N/m | 11.42 | 11.79 | 0.37 | mm | 245 g |
| Example 4 | | | | | | | | | | | | | |

As Table 1 reveals, the quantity of springback was relatively large in Comparative Examples 1 to 3 in which both the peel strengths A and B were decreased and the difference between the peel strength A and the peel strength B was set to 0.1 N/m or less. In Comparative Example 4 in which both the peel strengths A and B were increased and the difference between the peel strength A and the peel strength B was set to 0.1 N/m or less, the introduced quantity of the electrolyte solution was relatively small. In contrast to these Comparative Examples 1 to 4, in Examples 1 to 3 in which the difference between the peel strength A and the peel strength B was set to 0.5 N/m or more, the occurrence of springback was suppressed and the liquid injection property was high. These results bear out the significance of the art disclosed herein.

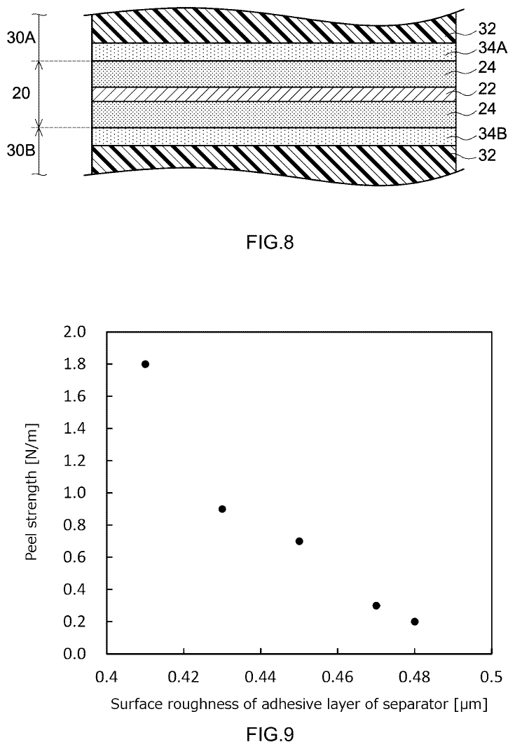

FIG. 9 is a graph expressing the relation between the surface roughness of the adhesive layer of the separator and the peel strength between the negative electrode and the separator. As shown in FIG. 9, as the surface roughness of the separator (here, the surface roughness of the adhesive layer) is larger, the peel strength tends to decrease. It is considered that this is because when the surface of the separator (here, the surface of the adhesive layer) has the irregularities, the bonding area with the negative electrode decreases and the adhesive strength decreases. As a result, it has been understood that the peel strength between the negative electrode and the separator can be adjusted at a desired value by adjusting the surface roughness of the separator, for example.

As described above, the following items are given as specific aspects of the art disclosed herein.
Item 1: The manufacturing method for a secondary battery, including: the first step of manufacturing the wound electrode body with the flat shape by stacking the first separator with the band shape, the positive electrode with the band shape, the second separator with the band shape, and the negative electrode with the band shape and winding the stack using the winding axis as the center; the second step of disposing one or the plurality of wound electrode bodies in the battery case; and the third step of injecting the electrolyte solution into the battery case, in which in the first step, the wound electrode body is manufactured in the manner that when the peel strength between the first separator and the negative electrode is A (N/m) and the peel strength between the second separator and the negative electrode is B (N/m), the difference between the peel strength A and the peel strength B is 0.5 (N/m) or more.
Item 2: The manufacturing method for a secondary battery according to Item 1, in which in the first step, the smaller one of the peel strength A and the peel strength B is 0.1 N/m or more.
Item 3: The manufacturing method for a secondary battery according to Item 1 or 2, in which in the first step, the first separator and the negative electrode are bonded to each other through the adhesive layer, and the second separator and the negative electrode are bonded to each other through the adhesive layer.
Item 4: The manufacturing method for a secondary battery according to any one of Items 1 to 3, in which in the second step, the plurality of wound electrode bodies are disposed in the battery case.
Item 5: The manufacturing method for a secondary battery according to any one of Items 1 to 4, in which in the first step, the negative electrode includes the negative electrode active material layer, and the length of the negative electrode active material layer in the winding axis direction is 250 mm or more.
Item 6: The manufacturing method for a secondary battery according to any one of Items 1 to 5, in which in the first step, the wound electrode body is manufactured while satisfying all of the following conditions: the positive electrode includes the positive electrode active material layer; the packing density of the positive electrode active material layer is 3.5 g/cm³ or more; the negative electrode includes the negative electrode active material layer; and the packing density of the negative electrode active material layer is 1.4 g/cm³ or more.
Item 7: The wound electrode body with the flat shape manufactured by stacking the first separator with the band shape, the positive electrode with the band shape, the second separator with the band shape, and the negative electrode with the band shape and winding the stack using the winding axis as the center, in which when the peel strength between the first separator and the negative electrode is A (N/m) and the peel strength between the second separator and the negative electrode is B (N/m), the difference between the peel strength A and the peel strength B is 0.5 (N/m) or more.
Item 8: The secondary battery including: the wound electrode body with the flat shape manufactured by stacking the first separator with the band shape, the positive electrode with the band shape, the second separator with the band shape, and the negative electrode with the band shape and winding the stack using the winding axis as the center; the electrolyte solution; and the battery case that accommodates one or the plurality of wound electrode bodies and the electrolyte solution, in which in the wound electrode body, when the peel strength between the first separator and the negative electrode is A (N/m) and the peel strength between the second separator and the negative electrode is B (N/m), the difference between the peel strength A and the peel strength B is 0.5 (N/m) or more.

Several embodiments of the present disclosure have been explained above, but these embodiments are merely illustrative in character. The present disclosure can be implemented in various other forms. The present disclosure can be implemented on the basis of the disclosure of the present specification and common technical knowledge in the relevant field. The art set forth in the scope of claims encompasses various modifications and alterations of the embodiments illustrated above. For example, a part of the aforementioned embodiment can be replaced by another modified aspect, and the other modified aspect can be added to the aforementioned embodiment. Moreover, a given feature may be expunged as appropriate if the feature is not explained as essential.

### REFERENCE SIGNS LIST

10 Positive electrode
20 Negative electrode
30A, 30B Separator
32 Base material layer
34A, 34B Adhesive layer
40 Wound electrode body
40f Flat portion
40r Curved portion
50 Battery case
100 Secondary battery

What is claimed is:

1. A manufacturing method for a secondary battery, comprising:
a first step of manufacturing a wound electrode body with a flat shape by stacking a first separator with a band shape, a positive electrode with a band shape, a second separator with a band shape, and a negative electrode with a band shape and winding the stack using a winding axis as a center;
a second step of disposing one or a plurality of the wound electrode bodies in a battery case; and
a third step of injecting an electrolyte solution into the battery case, wherein
in the first step, the wound electrode body is manufactured in a manner that when peel strength between the first separator and the negative electrode is A (N/m) and peel strength between the second separator and the negative electrode is B (N/m), a difference between the peel strength A and the peel strength B is 0.5 (N/m) or more.

2. The manufacturing method for a secondary battery according to claim 1, wherein in the first step, the smaller one of the peel strength A and the peel strength B is 0.1 N/m or more.

3. The manufacturing method for a secondary battery according to claim 1, wherein in the first step, the first separator and the negative electrode are bonded to each other through an adhesive layer, and the second separator and the negative electrode are bonded to each other through an adhesive layer.

4. The manufacturing method for a secondary battery according to claim 1, wherein in the second step, the plurality of wound electrode bodies are disposed in the battery case.

5. The manufacturing method for a secondary battery according to claim 1, wherein in the first step, the negative electrode includes a negative electrode active material layer, and a length of the negative electrode active material layer in a winding axis direction is 250 mm or more.

6. The manufacturing method for a secondary battery according to claim 1, wherein in the first step, the wound electrode body is manufactured while satisfying all of the following conditions:
the positive electrode includes a positive electrode active material layer;
a packing density of the positive electrode active material layer is 3.5 g/cm³ or more;
the negative electrode includes a negative electrode active material layer; and
a packing density of the negative electrode active material layer is 1.4 g/cm³ or more.

7. A wound electrode body with a flat shape manufactured by stacking a first separator with a band shape, a positive electrode with a band shape, a second separator with a band shape, and a negative electrode with a band shape and winding the stack using a winding axis as a center, wherein when peel strength between the first separator and the negative electrode is A (N/m) and peel strength between the second separator and the negative electrode is B (N/m), a difference between the peel strength A and the peel strength B is 0.5 (N/m) or more.

8. A secondary battery comprising:
a wound electrode body with a flat shape manufactured by stacking a first separator with a band shape, a positive electrode with a band shape, a second separator with a band shape, and a negative electrode with a band shape and winding the stack using a winding axis as a center;
an electrolyte solution; and
a battery case that accommodates one or a plurality of the wound electrode bodies and the electrolyte solution, wherein in the wound electrode body, when peel strength between the first separator and the negative electrode is A (N/m) and peel strength between the second separator and the negative electrode is B (N/m), a difference between the peel strength A and the peel strength B is 0.5 (N/m) or more.
